(19) United States
(12) Patent Application Publication
(10) Pub. No.: US 2015/0116563 A1
(43) Pub. Date: Apr. 30, 2015

(54) Adaptive Sensing of a Programmable Modulator System

(71) Applicant: InView Technology Corporation, Austin, TX (US)

(72) Inventors: Matthew A. Herman, Austin, TX (US); Justin A. Fritz, Austin, TX (US)

(73) Assignee: INVIEW TECHNOLOGY CORPORATION, Austin, TX (US)

(21) Appl. No.: 14/527,459

(22) Filed: Oct. 29, 2014

Related U.S. Application Data
(60) Provisional application No. 61/897,133, filed on Oct. 29, 2013.

(51) Int. Cl. H04N 5/378

(52) U.S. Cl. CPC H04N 5/378
USPC 348/302

(57) ABSTRACT

A technique to collect measurements that are adapted to a signal/scene of interest is presented. The measurements are correlations with patterns that serve as modulating waveforms. The patterns correspond respectively to rows of a sensing matrix. The method uses a sensing matrix whose rows are partitioned into blocks. Each block corresponds to a distinct feature or salient property of the scene. For each block, the method collects a number of measurements of the signal/scene based on selected rows of the block, and generates one or more associated statistics for the block based on said measurements. The statistics for the blocks are then analyzed (e.g., sorted) to determine the most important blocks. Subsequent measurements of the signal/scene may be based on rows from those most important blocks. The original measurements and/or the subsequent measurements may then be used in an algorithm to reconstruct the signal/scene.

### RELATED APPLICATION DATA

This application claims the benefit of priority to U.S. Provisional Application No. 61/897,133, filed on Oct. 29, 2013, titled “Adaptive Sensing of a Programmable Spatial Light Modulator System”, invented by Matthew A. Herman and Justin A. Fritz, which is hereby incorporated by reference in its entirety as though fully and completely set forth herein.

### FIELD OF THE INVENTION

The present invention relates to the field of compressive sensing, and more particularly, to a mechanism for adaptively sensing features in a signal or scene of interest, enabling more efficient sampling.

### DESCRIPTION OF THE RELATED ART

According to Nyquist theory, a signal x(t) whose signal energy is supported on the frequency interval [−B,B] may be reconstructed from samples {x(nT)} of the signal x(t), provided the rate f_{S}=1/T_{S} at which the samples are captured is sufficiently high, i.e., provided that f_{S} is greater than 2B. Similarly, for a signal whose signal energy is supported on the frequency interval [A,B], the signal may be reconstructed from samples captured with sample rate greater than B−A. A fundamental problem with any attempt to capture a signal x(t) according to Nyquist theory is the large number of samples that are generated, especially when B (or B−A) is large. The large number of samples is taxing on memory resources and on the capacity of transmission channels.

Nyquist theory is not limited to functions of time. Indeed, Nyquist theory applies more generally to any function of one or more real variables. For example, Nyquist theory applies to functions of two spatial variables such as images, to functions of time and two spatial variables such as video, and to the functions used in multispectral imaging, hyperspectral imaging, medical imaging and a wide variety of other applications. In the case of an image I(x,y) that depends on spatial variables x and y, the image may be reconstructed from samples of the image, provided the samples are captured with sufficiently high spatial density. For example, given samples {I(nΔx,mΔy)} captured along a rectangular grid, the horizontal and vertical densities 1/Δx and 1/Δy should be respectively greater than 2Bₓ and 2B_{y}, where Bₓ and B_{y} are the highest x and y spatial frequencies occurring in the image I(x,y). The same problem of overwhelming data volume is experienced when attempting to capture an image according to Nyquist theory. The modem theory of compressive sensing is directed to such problems.

Compressive sensing relies on the observation that many signals (e.g., images or video sequences) of practical interest are not only band-limited but also sparse or approximately sparse when represented using an appropriate choice of transformation, for example, a transformation such as a Fourier transform, a wavelet transform or a discrete cosine transform (DCT). A signal vector v is said to be K-sparse with respect to a given transformation G when the transformation of the signal vector, Gv, has no more than K non-zero coefficients. A signal vector v is said to be sparse with respect to a given transformation G when it is K-sparse with respect to that transformation for some integer K much smaller than the number L of components in the transformation vector Gv.

A signal vector v is said to be approximately K-sparse with respect to a given transformation G when the coefficients of the transformation vector, Gv, are dominated by the K largest coefficients (i.e., largest in the sense of magnitude or absolute value). In other words, if the K largest coefficients account for a high percentage of the energy in the entire set of coefficients, then the signal vector v is approximately K-sparse with respect to transformation G. A signal vector v is said to be approximately sparse with respect to a given transformation G when it is approximately K-sparse with respect to the transformation G for some integer K much less than the number L of components in the transformation vector Gv.

Given a sensing device that captures images with N samples per image and in conformity to the Nyquist condition on spatial rates, it is often the case that there exists some transformation and some integer K very much smaller than N such that the transform of each captured image will be approximately K sparse. The set of K dominant coefficients may vary from one image to the next. Furthermore, the value of K and the selection of the transformation may vary from one context (e.g., imaging application) to the next. Examples of typical transforms that might work in different contexts include the Fourier transform, the wavelet transform, the DCT, the Gabor transform, etc.

Compressive sensing specifies a way of operating on the N samples of an image so as to generate a much smaller set of samples from which the N samples may be reconstructed, given knowledge of the transform under which the image is sparse (or approximately sparse). In particular, compressive sensing invites one to think of the N samples as a vector v in an N-dimensional space and to imagine projecting the vector v onto each vector in a series of M vectors {R(i): i=1, 2, . . . , M} in the N-dimensional space, where M is larger than K but still much smaller than N. Each projection gives a corresponding real number S(i), e.g., according to the expression

S(i)=<v,R(i)>,

where the notation <v,R(i)> represents the inner product (or dot product) of the vector v and the vector R(i). Thus, the series of M projections gives a vector U including M real numbers: Uᵢ=S(i). Compressive sensing theory further prescribes methods for reconstructing (or estimating) the vector v of N samples from the vector U of M real numbers and the series of measurement vectors {R(i): i=1, 2, . . . , M}. For example, according to one method, one should determine the vector x that has the smallest length (in the sense of the L₁ norm) subject to the condition that ΦTx=U, where Φ is a matrix whose rows are the transposes of the vectors R(i), where T is a transformation under which the image is K sparse or approximately K sparse.

Compressive sensing is important because, among other reasons, it allows reconstruction of an image based on M measurements instead of the much larger number of measurements N recommended by Nyquist theory. Thus, for example, a compressive sensing camera would be able to capture a significantly larger number of images for a given size of image store, and/or, transmit a significantly larger number of images per unit time through a communication channel of given capacity.

As mentioned above, compressive sensing operates by projecting the image vector v onto a series of M vectors. As discussed in U.S. Pat. No. 8,199,244, issued Jun. 12, 2012 (invented by Baraniuk et al.) and illustrated in FIG. 1, an imaging device (e.g., camera) may be configured to take advantage of the compressive-sensing paradigm by using a digital micromirror device (DMD) 40. An incident lightfield 10 passes through a lens 20 and then interacts with the DMD 40. The DMD includes a two-dimensional array of micromirrors, each of which is configured to independently and controllably switch between two orientation states. Each micromirror reflects a corresponding portion of the incident light field based on its instantaneous orientation. Any micromirrors in a first of the two orientation states will reflect their corresponding light portions so that they pass through lens 50. Any micromirrors in a second of the two orientation states will reflect their corresponding light portions away from lens 50. Lens 50 serves to concentrate the light portions from micromirrors in the first orientation state onto a photodiode (or photodetector) situated at location 60. Thus, the photodiode generates a signal whose amplitude at any given time represents a sum of the intensities of the light portions from the micromirrors in the first orientation state.

The compressive sensing is implemented by driving the orientations of the micromirrors through a series of spatial patterns. Each spatial pattern specifies an orientation state for each of the micromirrors. Each of the spatial patterns may be derived from a corresponding row of the matrix Φ, e.g., by wrapping the corresponding row into a 2D array whose dimensions match the dimensions of the micromirror array. The output signal of the photodiode is digitized by an A/D converter 70. In this fashion, the imaging device is able to capture a series of measurements {S(i)} that represent inner products (dot products) between the incident light field and the series of spatial patterns without first acquiring the incident light field as a pixelized digital image. The incident light field corresponds to the vector v of the discussion above, and the spatial patterns correspond to the vectors R(i) of the discussion above.

The incident light field may be modeled by a function I(x,y,t) of two spatial variables and time. Assuming for the sake of discussion that the DMD comprises a rectangular array, the DMD implements a spatial modulation of the incident light field so that the light field leaving the DMD in the direction of the lens 50 might be modeled by

{I(nΔx,mΔ,y,t)*M(n,m,t)}

where m and n are integer indices, where I(nΔx,mΔy,t) represents the portion of the light field that is incident upon that (n,m)^{th} mirror of the DMD at time t. The function M(n,m,t) represents the orientation of the (n,m)^{th} mirror of the DMD at time t. At sampling times, the function M(n,m,t) equals one or zero, depending on the state of the digital control signal that controls the (n,m)^{th} mirror. The condition M(n,m,t)=1 corresponds to the orientation state that reflects onto the path that leads to the lens 50. The condition M(n,m,t)=0 corresponds to the orientation state that reflects away from the lens 50.

The lens 50 concentrates the spatially-modulated light field

{I(nΔx,mΔy,t)*M(n,m,t)}

onto a light sensitive surface of the photodiode. Thus, the lens and the photodiode together implement a spatial summation of the light portions in the spatially-modulated light field:

$$S ( t ) = {\sum }_{n , m} I ( n Δ x , m Δ y , t ) M ( n , m , t ) .$$

Signal S(t) may be interpreted as the intensity at time t of the concentrated spot of light impinging upon the light sensing surface of the photodiode. The A/D converter captures measurements of S(t). In this fashion, the compressive sensing camera optically computes an inner product of the incident light field with each spatial pattern imposed on the mirrors. The multiplication portion of the inner product is implemented by the mirrors of the DMD. The summation portion of the inner product is implemented by the concentrating action of the lens and also the integrating action of the photodiode.

A complete set of sensing patterns for an N-element spatial light modulator may consist of an N×N matrix. Rows of this matrix form the sensing patterns that are used with a spatial light modulator such as a digital micromirror device (DMD). Often a structured matrix is used (e.g., a Hadamard matrix). If the rows of the matrix are too structured (for example, if they are too coherent with respect to the sparsifying basis), then its columns can be “scrambled” by applying a pseudo-random permutation operator, or by pseudo-randomly inverting the polarity by multiplying with a random diagonal matrix with values drawn from {+1,−1} on its main diagonal. More background is available in:
U.S. patent application Ser. No. 14/154,817, filed on Jan. 14, 2014, titled “Generating Modulation Patterns for the Acquisition of Multiscale Information in Received Signals”, invented by Matthew A. Herman; and
U.S. Provisional Application No. 61/753,359, filed on Jan. 16, 2013, titled “Sensing with Multiscale Hadamard Waveforms”, invented by Matthew A. Herman.
   The above-identified applications are incorporated by reference in their entireties as though fully and completely set forth herein.

### SUMMARY

In compressive sensing and other sub-sampling modalities, it is advantageous to obtain the most information of a signal or scene of interest with the fewest number of possible measurements. Often, one does not have a priori information as to which of the N potential measurements to take. However, by partitioning the N possible measurements into distinct blocks, with each block corresponding to a respective signal/scene feature, we can gather relatively few measurements from each block, to generate a set of relevant statistics. Part of this technique relies on a so-called “incoherence” property of many sensing matrices in compressive sensing, which serves to spread out the information in the measurement domain (i.e., the information is not sparse in the measurement domain). This permits us to initially sub-sample (say, less than 1%) within each block while still producing a sufficient statistic. Once the statistics for all blocks have been gathered, they can be sorted to determine the most important blocks from which to draw measurements. The statistics can also be used to determine the total number of measurements M to be taken per image (or signal window), as well as the relative density of measurements within the chosen blocks. The M measurements can then be processed in a variety of applications, e.g., in the imaging of observed scenes.

### BRIEF DESCRIPTION OF THE DRAWINGS

A better understanding of the present invention can be obtained when the following detailed description of the preferred embodiments is considered in conjunction with the following drawings.

FIG. 1 illustrates a compressive sensing camera according to the prior art.

FIG. 2A illustrates one embodiment of a system 100 that is operable to capture compressive imaging samples and also samples of background light level. (LMU is an acronym for “light modulation unit”. MLS is an acronym for “modulated light stream”. LSD is an acronym for “light sensing device”.)

FIG. 2B illustrates an embodiment of system 100 that includes a processing unit 150.

FIG. 2C illustrates an embodiment of system 100 that includes an optical subsystem 105 to focus received light L onto the light modulation unit 110.

FIG. 2D illustrates an embodiment of system 100 that includes an optical subsystem 117 to direct or focus or concentrate the modulated light stream MLS onto the light sensing device 130.

FIG. 2E illustrates an embodiment where the optical subsystem 117 is realized by a lens 117L.

FIG. 2F illustrates an embodiment of system 100 that includes a control unit that is configured to supply a series of spatial patterns to the light modulation unit 110.

FIG. 3A illustrates system 200, where the light modulation unit 110 is realized by a plurality of mirrors (collectively referenced by label 110M).

FIG. 3B shows an embodiment of system 200 that includes the processing unit 150.

FIG. 4 shows an embodiment of system 200 that includes the optical subsystem 117 to direct or focus or concentrate the modulated light stream MLS onto the light sensing device 130.

FIG. 5A shows an embodiment of system 200 where the optical subsystem 117 is realized by the lens 117L.

FIG. 5B shows an embodiment of system 200 where the optical subsystem 117 is realized by a mirror 117M and lens 117L in series.

FIG. 5C shows another embodiment of system 200 that includes a TIR prism pair 107.

FIGS. 6A-6C illustrate a close-up of horizontal spokes in a star-sector target.

FIG. 6A shows the full spectrum of a Hadamard domain, partitioned into F=64 signature blocks. (Compare which blocks have significant energy here as compared to FIG. 7A.) FIG. 6B shows the “Partial-Complete” measurements that were selected from strongest thirty-two (32) blocks. FIG. 6C shows the reconstructed image resulting from the “Partial-Complete” measurements.

FIGS. 7A-7C illustrate a close-up of vertical spokes in a star-sector target. FIG. 7A shows the full spectrum of a Hadamard domain, partitioned into F=64 signature blocks. (Compare which blocks have significant energy here as compared to FIG. 6A.) FIG. 7B shows the “Partial-Complete” measurements that were selected from strongest thirty-two (32) blocks. FIG. 7C shows the reconstructed image resulting from the “Partial-Complete” measurements.

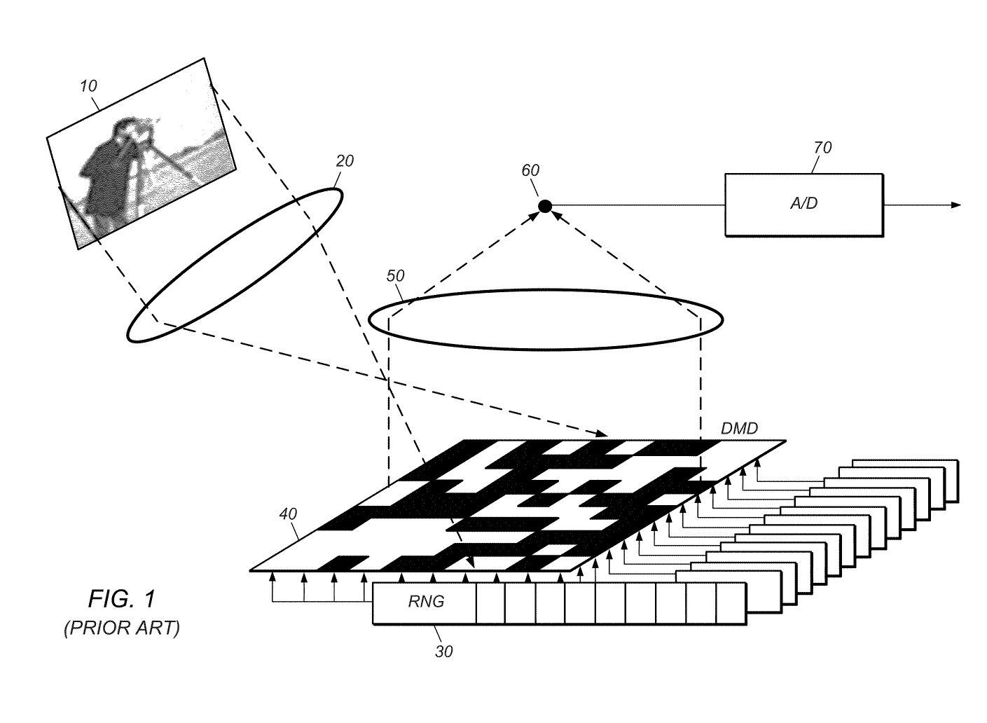

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

### Incorporations by Reference

The following documents are hereby incorporated by reference in their entireties as though fully and completely set forth herein.

U.S. patent application Ser. No. 13/207,900, filed Aug. 11, 2011, entitled “TIR Prism to Separate Incident Light and Modulated Light in Compressive Imaging Device”, invented by McMackin and Chatterjee;

U.S. patent application Ser. No. 13/197,304, filed Aug. 3, 2011, entitled “Decreasing Image Acquisition Time for Compressive Imaging Devices”, invented by Kelly, Baraniuk, McMackin, Bridge, Chatterjee and Weston;

U.S. patent application Ser. No. 14/106,542, filed Dec. 13, 2013, entitled “Overlap Patterns and Image Stitching for Multiple-Detector Compressive-Sensing Camera”, invented by Herman, Hewitt, Weston and McMackin.

### Terminology

A memory medium is a non-transitory medium configured for the storage and retrieval of information. Examples of memory media include: various kinds of semiconductor-based memory such as RAM and ROM; various kinds of magnetic media such as magnetic disk, tape, strip and film; various kinds of optical media such as CD-ROM and DVD-ROM; various media based on the storage of electrical charge and/or any of a wide variety of other physical quantities; media fabricated using various lithographic techniques; etc. The term “memory medium” includes within its scope of meaning the possibility that a given memory medium might be a union of two or more memory media that reside at different locations, e.g., in different portions of an integrated circuit or on different integrated circuits in an electronic system or on different computers in a computer network.

A computer-readable memory medium may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

A computer system is any device (or combination of devices) having at least one processor that is configured to execute program instructions stored on a memory medium. Examples of computer systems include personal computers (PCs), workstations, laptop computers, tablet computers, mainframe computers, server computers, client computers, network or Internet appliances, hand-held devices, mobile devices, personal digital assistants (PDAs), tablet computers, computer-based television systems, grid computing systems, wearable computers, computers implanted in living organisms, computers embedded in head-mounted displays, computers embedded in sensors forming a distributed network, computers embedded in a camera devices or imaging devices or spectral measurement devices, etc.

A programmable hardware element (PHE) is a hardware device that includes multiple programmable function blocks connected via a system of programmable interconnects. Examples of PHEs include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores).

As used herein, the term “light” is meant to encompass within its scope of meaning any electromagnetic radiation whose spectrum lies within the wavelength range [λ_{L}, λ_{U}], where the wavelength range includes the visible spectrum, the ultra-violet (UV) spectrum, infrared (IR) spectrum and the terahertz (THz) spectrum. Thus, for example, visible radiation, or UV radiation, or IR radiation, or THz radiation, or any combination thereof is “light” as used herein.

In some embodiments, a computer system may be configured to include a processor (or a set of processors) and a memory medium, where the memory medium stores program instructions, where the processor is configured to read and execute the program instructions stored in the memory medium, where the program instructions are executable by the processor to implement a method, e.g., any of the various method embodiments described herein, or, any combination of the method embodiments described herein, or, any subset of any of the method embodiments described herein, or, any combination of such subsets.

System 100 for Operating on Light

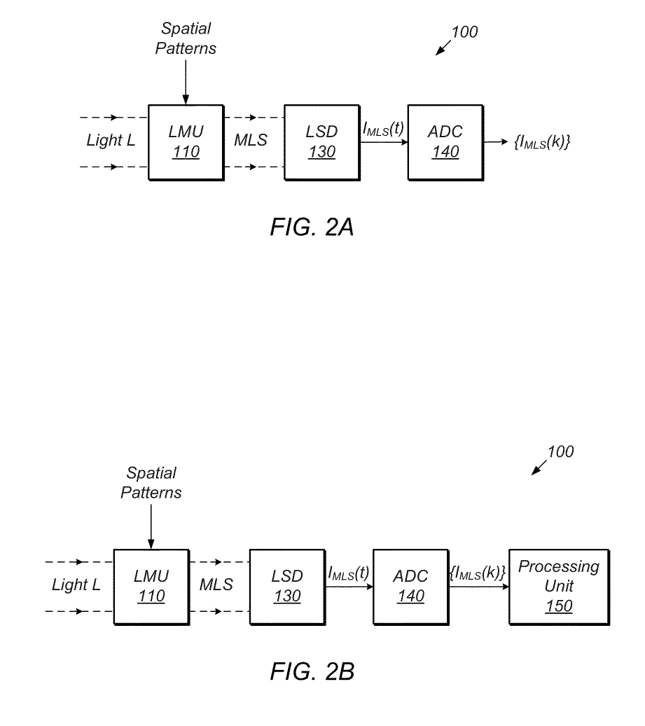

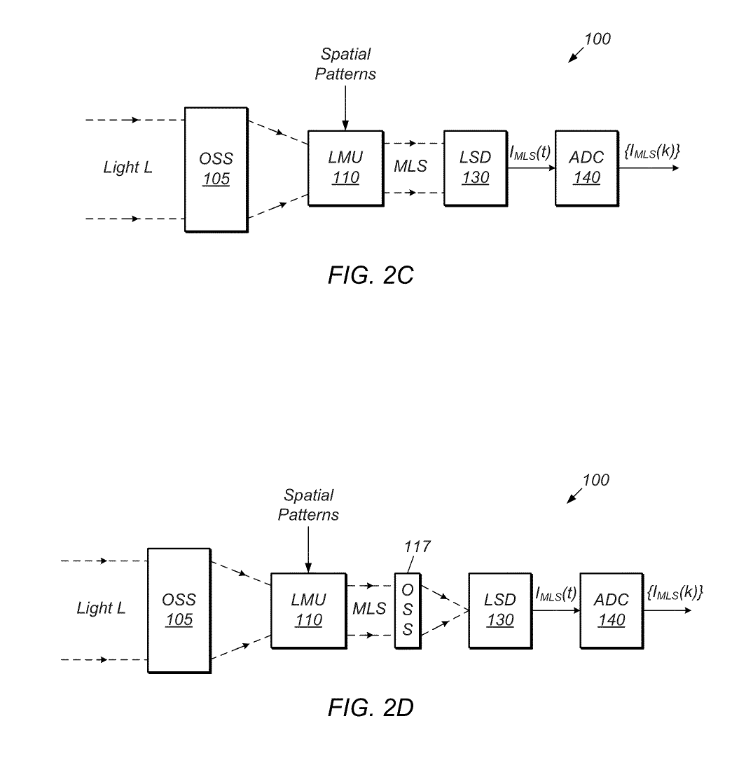

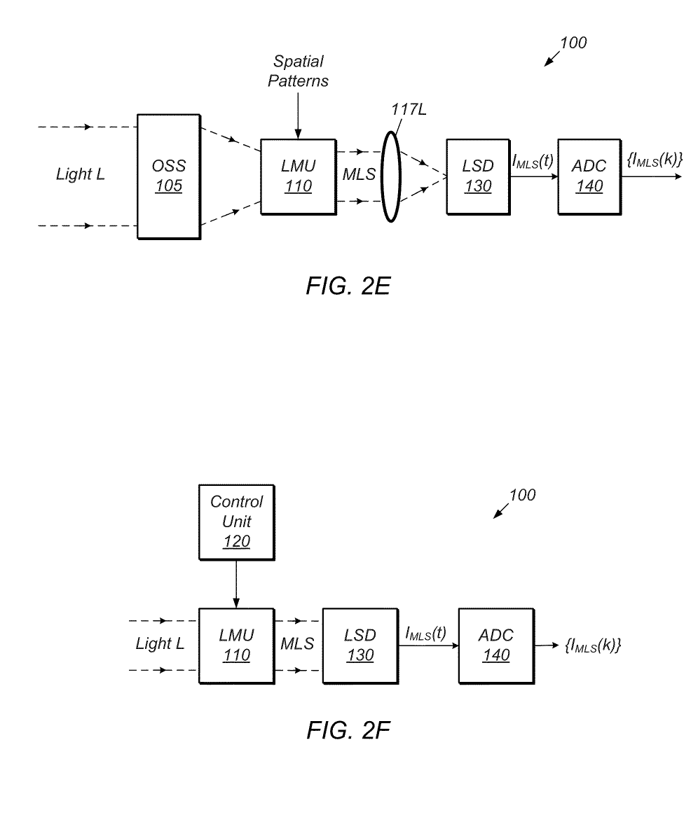

A system 100 for operating on light may be configured as shown in FIG. 2A. The system 100 may include a light modulation unit 110, a light sensing device 130 and an analog-to-digital converter (ADC) 140.

The light modulation unit 110 is configured to modulate a received stream of light L with a series of spatial patterns in order to produce a modulated light stream (MLS). The spatial patterns of the series may be applied sequentially to the light stream so that successive time slices of the light stream are modulated, respectively, with successive ones of the spatial patterns. (The action of sequentially modulating the light stream L with the spatial patterns imposes the structure of time slices on the light stream.) The light modulation unit 110 includes a plurality of light modulating elements configured to modulate corresponding portions of the light stream. Each of the spatial patterns specifies an amount (or extent or value) of modulation for each of the light modulating elements. Mathematically, one might think of the light modulation unit's action of applying a given spatial pattern as performing an element-wise multiplication of a light field vector (xᵢⱼ) representing a time slice of the light stream L by a vector of scalar modulation values (mᵢⱼ), to obtain a time slice of the modulated light stream: (mᵢⱼ)*(xᵢⱼ)=(mᵢⱼ*xᵢⱼ). The vector (mᵢⱼ) is specified by the spatial pattern. Each light modulating element effectively scales (multiplies) the intensity of its corresponding light stream portion by the corresponding scalar factor.

The light modulation unit 110 may be realized in various ways. In some embodiments, the LMU 110 may be realized by a plurality of mirrors (e.g., micromirrors) whose orientations are independently controllable. In another set of embodiments, the LMU 110 may be realized by an array of elements whose transmittances are independently controllable, e.g., as with an array of LCD shutters. An electrical control signal supplied to each element controls the extent to which light is able to transmit through the element. In yet another set of embodiments, the LMU 110 may be realized by an array of independently-controllable mechanical shutters (e.g., micromechanical shutters) that cover an array of apertures, with the shutters opening and closing in response to electrical control signals, thereby controlling the flow of light through the corresponding apertures. In yet another set of embodiments, the LMU 110 may be realized by a perforated mechanical plate, with the entire plate moving in response to electrical control signals, thereby controlling the flow of light through the corresponding perforations. In yet another set of embodiments, the LMU 110 may be realized by an array of transceiver elements, where each element receives and then immediately retransmits light in a controllable fashion. In yet another set of embodiments, the LMU 110 may be realized by a grating light valve (GLV) device. In yet another embodiment, the LMU 110 may be realized by a liquid-crystal-on-silicon (LCOS) device.

In some embodiments, the light modulating elements are arranged in an array, e.g., a two-dimensional array or a one-dimensional array. Any of various array geometries are contemplated. For example, in some embodiments, the array is a square array or rectangular array.

Let N denote the number of light modulating elements in the light modulation unit 110. In various embodiments, the number N may take a wide variety of values. The particular value used in any given embodiment may depend on one or more factors specific to the embodiment.

The light sensing device 130 may be configured to receive the modulated light stream MLS and to generate an analog electrical signal I_{MLS}(t) representing intensity of the modulated light stream as a function of time.

The light sensing device 130 may include one or more light sensing elements. The term “light sensing element” may be interpreted as meaning “a transducer between a light signal and an electrical signal”. For example, a photodiode is a light sensing element. In various other embodiments, light sensing elements might include devices such as metal-semiconductor-metal (MSM) photodetectors, phototransistors, phototubes and photomultiplier tubes.

The ADC 140 acquires a sequence of samples {I_{MLS}(k)} of the analog electrical signal I_{MLS}(t). Each of the samples may be interpreted as an inner product between a corresponding time slice of the light stream L and a corresponding one of the spatial patterns. The set of samples {I_{MLS}(k)} comprises an encoded representation, e.g., a compressed representation, of an image (or a video sequence) and may be used to reconstruct the image (or video sequence) based on any reconstruction algorithm known in the field of compressive sensing. (For video sequence reconstruction, the samples may be partitioned into contiguous subsets, and then the subsets may be processed to reconstruct corresponding images.)

In some embodiments, the light sensing device 130 includes exactly one light sensing element. (For example, the single light sensing element may be a photodiode.) The light sensing element may couple to an amplifier (e.g., a TIA) (e.g., a multi-stage amplifier).

In some embodiments, the light sensing device 130 may include a plurality of light sensing elements (e.g., photodiodes). Each light sensing element may convert light impinging on its light sensing surface into a corresponding analog electrical signal representing intensity of the impinging light as a function of time. In some embodiments, each light sensing element may couple to a corresponding amplifier so that the analog electrical signal produced by the light sensing element can be amplified prior to digitization. System 100 may be configured so that each light sensing element receives, e.g., a corresponding spatial portion (or spectral portion) of the modulated light stream.

In one embodiment, the analog electrical signals produced, respectively, by the light sensing elements may be summed to obtain a sum signal. The sum signal may then be digitized by the ADC 140 to obtain the sequence of samples {I_{MLS}(k)}. In another embodiment, the analog electrical signals may be individually digitized, each with its own ADC, to obtain corresponding sample sequences. The sample sequences may then be added to obtain the sequence {I_{MLS}(k)}. In another embodiment, the analog electrical signals produced by the light sensing elements may be sampled by a smaller number of ADCs than light sensing elements through the use of time multiplexing. For example, in one embodiment, system 100 may be configured to sample two or more of the analog electrical signals by switching the input of an ADC among the outputs of the two or more corresponding light sensing elements at a sufficiently high rate.

In some embodiments, the light sensing device 130 may include an array of light sensing elements. Arrays of any of a wide variety of sizes, configurations and material technologies are contemplated. In one embodiment, the light sensing device 130 includes a focal plane array coupled to a readout integrated circuit. In one embodiment, the light sensing device 130 may include an array of cells, where each cell includes a corresponding light sensing element and is configured to integrate and hold photo-induced charge created by the light sensing element, and to convert the integrated charge into a corresponding cell voltage. The light sensing device may also include (or couple to) circuitry configured to sample the cell voltages using one or more ADCs.

In some embodiments, the light sensing device 130 may include a plurality (or array) of light sensing elements, where each light sensing element is configured to receive a corresponding spatial portion of the modulated light stream, and each spatial portion of the modulated light stream comes from a corresponding sub-region of the array of light modulating elements. (For example, the light sensing device 130 may include a quadrant photodiode, where each quadrant of the photodiode is configured to receive modulated light from a corresponding quadrant of the array of light modulating elements. As another example, the light sensing device 130 may include a bi-cell photodiode. As yet another example, the light sensing device 130 may include a focal plane array.) Each light sensing element generates a corresponding signal representing intensity of the corresponding spatial portion as a function of time. Each signal may be digitized (e.g., by a corresponding ADC, or perhaps by a shared ADC) to obtain a corresponding sequence of samples. Thus, a plurality of sample sequences are obtained, one sample sequence per light sensing element. Each sample sequence may be processed to reconstruct a corresponding sub-image (or sub-video sequence). The sub-images may be joined together to form a whole image (or whole video sequence). The sample sequences may be captured in response to the modulation of the incident light stream with a sequence of M spatial patterns, e.g., as variously described above. By employing any of various reconstruction algorithms known in the field of compressive sensing, the number of pixels (voxels) in each reconstructed image (sub-video sequence) may be greater than (e.g., much greater than) M. To reconstruct each sub-image (sub-video), the reconstruction algorithm uses the corresponding sample sequence and the restriction of the spatial patterns to the corresponding sub-region of the array of light modulating elements.

In some embodiments, the system 100 may include a memory (or a set of memories of one or more kinds).

In some embodiments, system 100 may include a processing unit 150, e.g., as shown in FIG. 2B. The processing unit 150 may be a digital circuit or a combination of digital circuits. For example, the processing unit may be a microprocessor (or system of interconnected of microprocessors), a programmable hardware element such as a field-programmable gate array (FPGA), an application specific integrated circuit (ASIC), or any combination such elements. The processing unit 150 may be configured to perform one or more functions such as image/video reconstruction, system control, user interface, statistical analysis, and one or more inferences tasks.

The system 100 (e.g., the processing unit 150) may store the samples {I_{MLS}(k)} in a memory, e.g., a memory resident in the system 100 or in some other system.

In one embodiment, processing unit 150 is configured to operate on the samples {I_{MLS}(k)} to generate the image or video sequence. In this embodiment, the processing unit 150 may include a microprocessor configured to execute software (i.e., program instructions), especially software for performing an image/video reconstruction algorithm. In one embodiment, system 100 is configured to transmit the compensated samples to some other system through a communication channel. (In embodiments where the spatial patterns are randomly-generated, system 100 may also transmit the random seed(s) used to generate the spatial patterns.) That other system may operate on the samples to reconstruct the image/video. System 100 may have one or more interfaces configured for sending (and perhaps also receiving) data through one or more communication channels, e.g., channels such as wireless channels, wired channels, fiber optic channels, acoustic channels, laser-based channels, etc.

In some embodiments, processing unit 150 is configured to use any of a variety of algorithms and/or any of a variety of transformations to perform image/video reconstruction.

In some embodiments, the system 100 is configured to acquire a set Z_{M} of samples from the ADC 140 so that the sample set Z_{M} corresponds to M of the spatial patterns applied to the light modulation unit 110, where M is a positive integer. The number M is selected so that the sample set Z_{M} is useable to reconstruct an n-pixel image or n-voxel video sequence that represents the incident light stream, where n is a positive integer less than or equal to the number N of light modulating elements in the light modulation unit 110. System 100 may be configured so that the number M is smaller than n. Thus, system 100 may operate as a compressive sensing device. (The number of “voxels” in a video sequence is the number of images in the video sequence times the number of pixels per image, or equivalently, the sum of the pixel counts of the images in the video sequence.)

In various embodiments, the compression ratio M/n may take any of a wide variety of values.

In some embodiments, system 100 may include an optical subsystem 105 that is configured to modify or condition the light stream L before it arrives at the light modulation unit 110, e.g., as shown in FIG. 2C. For example, the optical subsystem 105 may be configured to receive the light stream L from the environment and to focus the light stream onto a modulating plane of the light modulation unit 110. The optical subsystem 105 may include a camera lens (or a set of lenses). The lens (or set of lenses) may be adjustable to accommodate a range of distances to external objects being imaged/sensed/captured. The optical subsystem 105 may allow manual and/or digital control of one or more parameters such as focus, zoom, shutter speed and f-stop.

In some embodiments, system 100 may include an optical subsystem 117 to direct the modulated light stream MLS onto a light sensing surface (or surfaces) of the light sensing device 130.

In some embodiments, the optical subsystem 117 may include one or more lenses, and/or, one or more mirrors.

In some embodiments, the optical subsystem 117 is configured to focus the modulated light stream onto the light sensing surface (or surfaces). The term “focus” implies an attempt to achieve the condition that rays (photons) diverging from a point on an object plane converge to a point (or an acceptably small spot) on an image plane. The term “focus” also typically implies continuity between the object plane point and the image plane point (or image plane spot); points close together on the object plane map respectively to points (or spots) close together on the image plane. In at least some of the system embodiments that include an array of light sensing elements, it may be desirable for the modulated light stream MLS to be focused onto the light sensing array so that there is continuity between points on the light modulation unit LMU and points (or spots) on the light sensing array.

In some embodiments, the optical subsystem 117 may be configured to direct the modulated light stream MLS onto the light sensing surface (or surfaces) of the light sensing device 130 in a non-focusing fashion. For example, in a system embodiment that includes only one photodiode, it may not be so important to achieve the “in focus” condition at the light sensing surface of the photodiode since positional information of photons arriving at that light sensing surface will be immediately lost.

In one embodiment, the optical subsystem 117 may be configured to receive the modulated light stream and to concentrate the modulated light stream into an area (e.g., a small area) on a light sensing surface of the light sensing device 130. Thus, the diameter of the modulated light stream may be reduced (possibly, radically reduced) in its transit from the optical subsystem 117 to the light sensing surface (or surfaces) of the light sensing device 130.

In some embodiments, this feature of concentrating the modulated light stream onto the light sensing surface (or surfaces) of the light sensing device allows the light sensing device to sense at any given time the sum (or surface integral) of the intensities of the modulated light portions within the modulated light stream. (Each time slice of the modulated light stream comprises a spatial ensemble of modulated light portions due to the modulation unit's action of applying the corresponding spatial pattern to the light stream.)

In some embodiments, the modulated light stream MLS may be directed onto the light sensing surface of the light sensing device 130 without concentration, i.e., without decrease in diameter of the modulated light stream, e.g., by use of photodiode having a large light sensing surface, large enough to contain the cross section of the modulated light stream without the modulated light stream being concentrated.

In some embodiments, the optical subsystem 117 may include one or more lenses. FIG. 2E shows an embodiment where optical subsystem 117 is realized by a lens 117L, e.g., a biconvex lens or a condenser lens.

In some embodiments, the optical subsystem 117 may include one or more mirrors. In one embodiment, the optical subsystem 117 includes a parabolic mirror (or spherical mirror) to concentrate the modulated light stream onto a neighborhood (e.g., a small neighborhood) of the parabolic focal point. In this embodiment, the light sensing surface of the light sensing device may be positioned at the focal point.

In some embodiments, system 100 may include an optical mechanism (e.g., an optical mechanism including one or more prisms and/or one or more diffraction gratings) for splitting or separating the modulated light stream MLS into two or more separate streams (perhaps numerous streams), where each of the streams is confined to a different wavelength range. The separate streams may each be sensed by a separate light sensing device. (In some embodiments, the number of wavelength ranges may be, e.g., greater than 8, or greater than 16, or greater than 64, or greater than 256, or greater than 1024.) Furthermore, each separate stream may be directed (e.g., focused or concentrated) onto the corresponding light sensing device as described above in connection with optical subsystem 117. The samples captured from each light sensing device may be used to reconstruct a corresponding image (or video sequence) for the corresponding wavelength range. In one embodiment, the modulated light stream is separated into red, green and blue streams to support color (R,G,B) measurements. In another embodiment, the modulated light stream may be separated into IR, red, green, blue and UV streams to support five-channel multi-spectral imaging: (IR, R, G, B, UV). In some embodiments, the modulated light stream may be separated into a number of sub-bands (e.g., adjacent sub-bands) within the IR band to support multi-spectral or hyper-spectral IR imaging. In some embodiments, the number of IR sub-bands may be, e.g., greater than 8, or greater than 16, or greater than 64, or greater than 256, or greater than 1024. In some embodiments, the modulated light stream may experience two or more stages of spectral separation. For example, in a first stage the modulated light stream may be separated into an IR stream confined to the IR band and one or more additional streams confined to other bands. In a second stage, the IR stream may be separated into a number of sub-bands (e.g., numerous sub-bands) (e.g., adjacent sub-bands) within the IR band to support multispectral or hyper-spectral IR imaging.

In some embodiments, system 100 may include an optical mechanism (e.g., a mechanism including one or more beam splitters) for splitting or separating the modulated light stream MLS into two or more separate streams, e.g., where each of the streams have the same (or approximately the same) spectral characteristics or wavelength range. The separate streams may then pass through respective bandpass filters to obtain corresponding modified streams, where each modified stream is restricted to a corresponding band of wavelengths. Each of the modified streams may be sensed by a separate light sensing device. (In some embodiments, the number of wavelength bands may be, e.g., greater than 8, or greater than 16, or greater than 64, or greater than 256, or greater than 1024.) Furthermore, each of the modified streams may be directed (e.g., focused or concentrated) onto the corresponding light sensing device as described above in connection with optical subsystem 117. The samples captured from each light sensing device may be used to reconstruct a corresponding image (or video sequence) for the corresponding wavelength band. In one embodiment, the modulated light stream is separated into three streams which are then filtered, respectively, with a red-pass filter, a green-pass filter and a blue-pass filter. The resulting red, green and blue streams are then respectively detected by three light sensing devices to support color (R,G,B) acquisition. In another similar embodiment, five streams are generated, filtered with five respective filters, and then measured with five respective light sensing devices to support (IR, R, G, B, UV) multi-spectral acquisition. In yet another embodiment, the modulated light stream of a given band may be separated into a number of (e.g., numerous) sub-bands to support multi-spectral or hyper-spectral imaging.

In some embodiments, system 100 may include an optical mechanism for splitting or separating the modulated light stream MLS into two or more separate streams. The separate streams may be directed to (e.g., concentrated onto) respective light sensing devices. The light sensing devices may be configured to be sensitive in different wavelength ranges, e.g., by virtue of their different material properties. Samples captured from each light sensing device may be used to reconstruct a corresponding image (or video sequence) for the corresponding wavelength range.

In some embodiments, system 100 may include a control unit 120 configured to supply the spatial patterns to the light modulation unit 110, as shown in FIG. 2F. The control unit may itself generate the patterns or may receive the patterns from some other agent. The control unit 120 and the ADC 140 may be controlled by a common clock signal so that ADC 140 can coordinate (synchronize) its action of capturing the samples {I_{MLS}(k)} with the control unit's action of supplying spatial patterns to the light modulation unit 110. (System 100 may include clock generation circuitry.)

In some embodiments, the control unit 120 may supply the spatial patterns to the light modulation unit in a periodic fashion.

The control unit 120 may be a digital circuit or a combination of digital circuits. For example, the control unit may include a microprocessor (or system of interconnected of microprocessors), a programmable hardware element such as a field-programmable gate array (FPGA), an application specific integrated circuit (ASIC), or any combination such elements.

In some embodiments, the control unit 120 may include a random number generator (RNG) or a set of random number generators to generate the spatial patterns or some subset of the spatial patterns.

In some embodiments, system 100 may include a display (or an interface configured for coupling to a display) for displaying reconstructed images/videos.

In some embodiments, system 100 may include one or more input devices (and/or, one or more interfaces for input devices), e.g., any combination or subset of the following devices: a set of buttons and/or knobs, a keyboard, a keypad, a mouse, a touch-sensitive pad such as a trackpad, a touch-sensitive display screen, one or more microphones, one or more temperature sensors, one or more chemical sensors, one or more pressure sensors, one or more accelerometers, one or more orientation sensors (e.g., a three-axis gyroscopic sensor), one or more proximity sensors, one or more antennas, etc.

Regarding the spatial patterns that are used to modulate the light stream L, it should be understood that there are a wide variety of possibilities. In some embodiments, the control unit 120 may be programmable so that any desired set of spatial patterns may be used.

In some embodiments, the spatial patterns are binary valued. Such an embodiment may be used, e.g., when the light modulating elements are two-state devices. In some embodiments, the spatial patterns are n-state valued, where each element of each pattern takes one of n states, where n is an integer greater than two. (Such an embodiment may be used, e.g., when the light modulating elements are each able to achieve n or more modulation states). In some embodiments, the spatial patterns are real valued, e.g., when each of the light modulating elements admits a continuous range of modulation. (It is noted that even a two-state modulating element may be made to effectively apply a continuous range of modulation by duty cycling the two states during modulation intervals.)

Coherence

The spatial patterns may belong to a set of measurement vectors that is incoherent with a set of vectors in which the image/video is approximately sparse (“the sparsity vector set”). (See “Sparse Signal Detection from Incoherent Projections”, Proc. Int. Conf. Acoustics, Speech Signal Processing—ICASSP, May 2006, Duarte et al.) Given two sets of vectors A={aᵢ} and B={bᵢ} in the same N-dimensional space, A and B are said to be incoherent if their coherence measure μ(A,B) is sufficiently small. Assuming that the vectors {aᵢ} and {bᵢ} each have unit L² norm, then coherence measure may be defined as:

$$μ ( A , B ) = {max}_{i , j} \vert 〈 {a}_{i} , {b}_{j} 〉 \vert .$$

The number of compressive sensing measurements (i.e., samples of the sequence {I_{MLS}(k)} needed to reconstruct an N-pixel image (or N-voxel video sequence) that accurately represents the scene being captured is a strictly increasing function of the coherence between the measurement vector set and the sparsity vector set. Thus, better compression can be achieved with smaller values of the coherence.

In some embodiments, the measurement vector set may be based on a code. Any of various codes from information theory may be used, e.g., codes such as exponentiated Kerdock codes, exponentiated Delsarte-Goethals codes, run-length limited codes, LDPC codes, Reed Solomon codes and Reed Muller codes.

In some embodiments, the measurement vector set corresponds to a randomized or permuted basis, where the basis may be, for example, the DCT basis (DCT is an acronym for Discrete Cosine Transform) or Hadamard basis.

In some embodiments, the spatial patterns may be random or pseudo-random patterns, e.g., generated according to a random number generation (RNG) algorithm using one or more seeds. In some embodiments, the elements of each pattern are generated by a series of Bernoulli trials, where each trial has a probability p of giving the value one and probability 1−p of giving the value zero. (For example, in one embodiment p=½.) In some embodiments, the elements of each pattern are generated by a series of draws from a Gaussian random variable.)

The system 100 may be configured to operate in a compressive fashion, where the number of the samples {I_{MLS}(k)} captured by the system 100 is less than (e.g., much less than) the number of pixels in the image (or video) to be reconstructed from the samples. In many applications, this compressive realization is very desirable because it saves on power consumption, memory utilization and transmission bandwidth consumption. However, non-compressive realizations are contemplated as well.

In some embodiments, the system 100 is configured as a camera or imager that captures information representing an image (or a series of images) from the external environment, e.g., an image (or a series of images) of some external object or scene. The camera system may take different forms in different application domains, e.g., domains such as visible light photography, infrared photography, ultraviolet photography, high-speed photography, low-light photography, underwater photography, multi-spectral imaging, hyper-spectral imaging, etc. In some embodiments, system 100 is configured to operate in conjunction with (or as part of) another system, e.g., in conjunction with (or as part of) a microscope, a telescope, a robot, a security system, a surveillance system, a fire sensor, a node in a distributed sensor network, etc.

In some embodiments, system 100 is configured as a spectrometer. In some embodiments, system 100 is configured as a multi-spectral or hyper-spectral imager. In some embodiments, system 100 may configured as a single integrated package, e.g., as a camera.

In one embodiment, the light modulation unit 110 may receive the light beam from the light source and modulate the light beam with a time sequence of spatial patterns (from a measurement pattern set). The resulting modulated light beam exits the system 100 and is used to illuminate the external scene. Light reflected from the external scene in response to the modulated light beam is measured by a light sensing device (e.g., a photodiode). The samples captured by the light sensing device comprise compressive measurements of external scene. Those compressive measurements may be used to reconstruct an image or video sequence as variously described above.

In some embodiments, system 100 includes an interface for communicating with a host computer. The host computer may send control information and/or program code to the system 100 via the interface. Furthermore, the host computer may receive status information and/or compressive sensing measurements from system 100 via the interface.

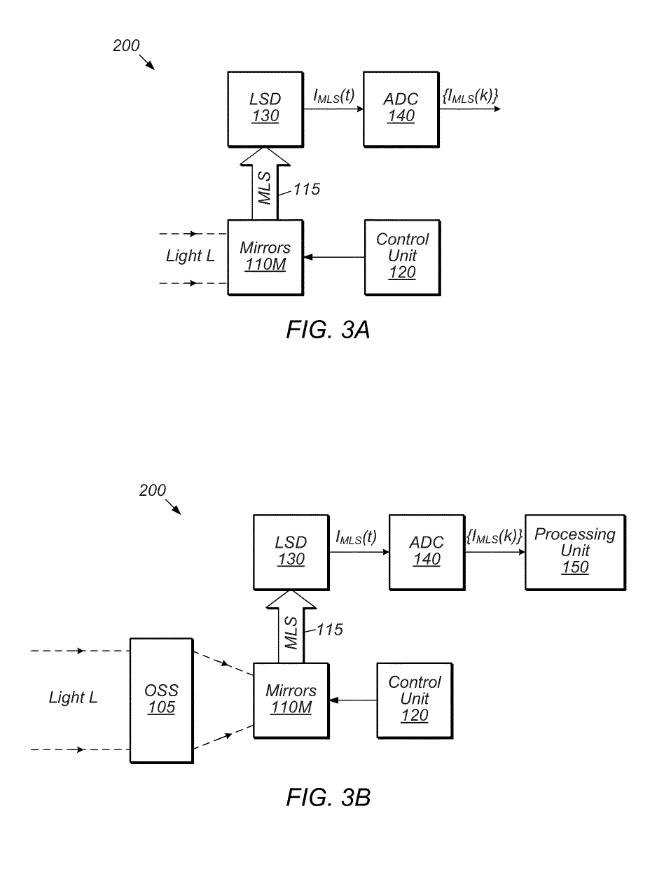

In one realization 200 of system 100, the light modulation unit 110 may be realized by a plurality of mirrors, e.g., as shown in FIG. 3A. (The mirrors are collectively indicated by the label 110M.) The mirrors 110M are configured to receive corresponding portions of the light L received from the environment, albeit not necessarily directly from the environment. (There may be one or more optical elements, e.g., one or more lenses along the input path to the mirrors 110M.) Each of the mirrors is configured to controllably switch between at least two orientation states. In addition, each of the mirrors is configured to (a) reflect the corresponding portion of the light onto a sensing path 115 when the mirror is in a first of the two orientation states and (b) reflect the corresponding portion of the light away from the sensing path when the mirror is in a second of the two orientation states.

In some embodiments, the mirrors 110M are arranged in an array, e.g., a two-dimensional array or a one-dimensional array. Any of various array geometries are contemplated. For example, in different embodiments, the array may be a square array, a rectangular array, a hexagonal array, etc. In some embodiments, the mirrors are arranged in a spatially-random fashion.

The mirrors 110M may be part of a digital micromirror device (DMD). For example, in some embodiments, one of the DMDs manufactured by Texas Instruments may be used.

The control unit 120 may be configured to drive the orientation states of the mirrors through the series of spatial patterns, where each of the patterns of the series specifies an orientation state for each of the mirrors.

The light sensing device 130 may be configured to receive the light portions reflected at any given time onto the sensing path 115 by the subset of mirrors in the first orientation state and to generate an analog electrical signal I_{MLS}(t) representing a cumulative intensity of the received light portions as function of time. As the mirrors are driven through the series of spatial patterns, the subset of mirrors in the first orientation state will vary from one spatial pattern to the next. Thus, the cumulative intensity of light portions reflected onto the sensing path 115 and arriving at the light sensing device will vary as a function time. Note that the term “cumulative” is meant to suggest a summation (spatial integration) over the light portions arriving at the light sensing device at any given time. This summation may be implemented, at least in part, optically (e.g., by means of a lens and/or mirror that concentrates or focuses the light portions onto a concentrated area as described above).

System realization 200 may include any subset of the features, embodiments and elements discussed above with respect to system 100. For example, system realization 200 may include the optical subsystem 105 to operate on the incoming light L before it arrives at the mirrors 110M, e.g., as shown in FIG. 3B.

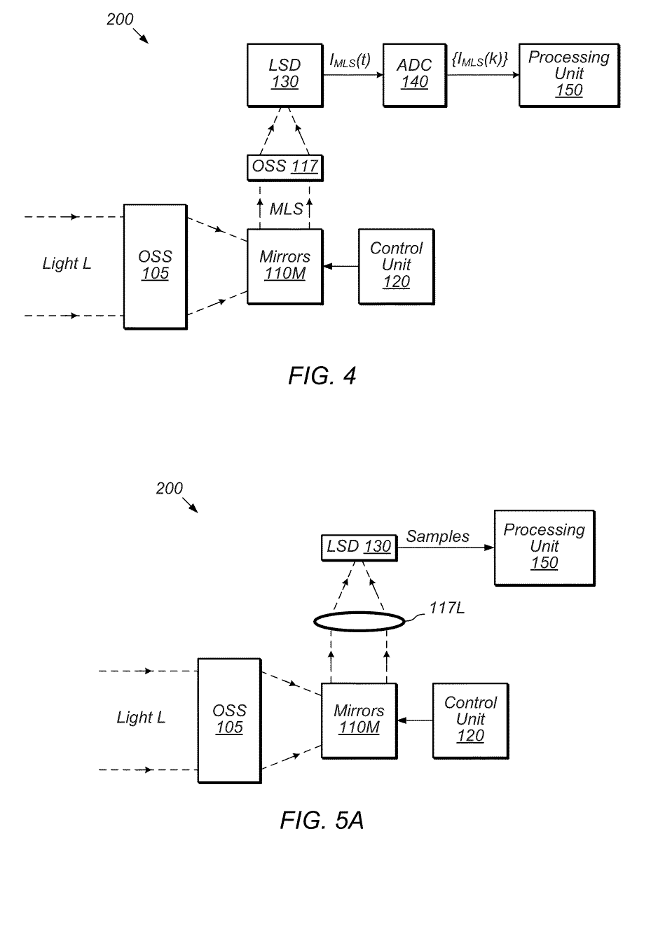

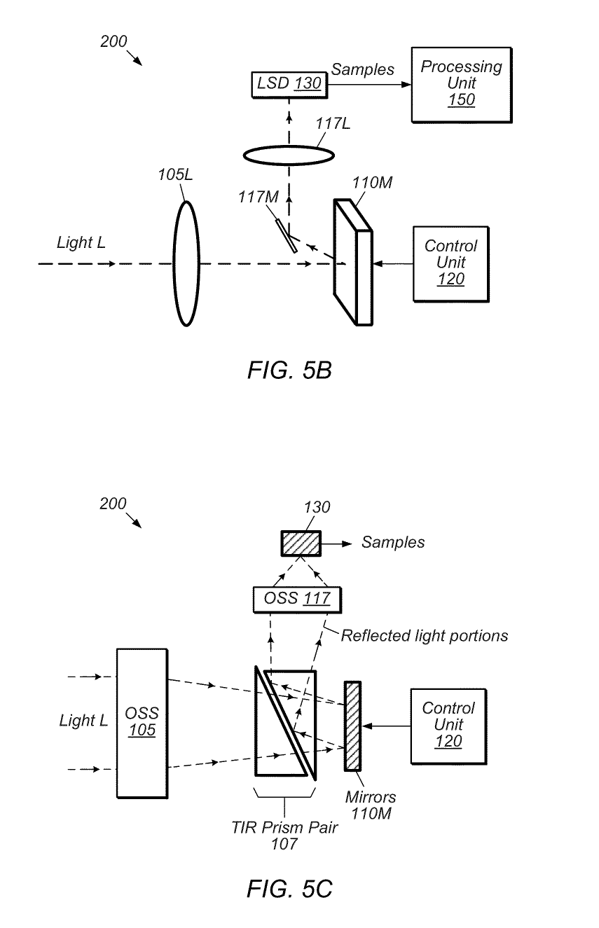

In some embodiments, system realization 200 may include the optical subsystem 117 along the sensing path as shown in FIG. 4. The optical subsystem 117 receives the light portions reflected onto the sensing path 115 and directs (e.g., focuses or concentrates) the received light portions onto a light sensing surface (or surfaces) of the light sensing device 130. In one embodiment, the optical subsystem 117 may include a lens 117L, e.g., as shown in FIG. 5A.

In some embodiments, the optical subsystem 117 may include one or more mirrors, e.g., a mirror 117M as shown in FIG. 5B. Thus, the sensing path may be a bent path having more than one segment. FIG. 5B also shows one possible embodiment of optical subsystem 105, as a lens 105L.

In some embodiments, there may be one or more optical elements intervening between the optical subsystem 105 and the mirrors 110M. For example, as shown in FIG. 5C, a TIR prism pair 107 may be positioned between the optical subsystem 105 and the mirrors 110M. (TIR is an acronym for “total internal reflection”.) Light from optical subsystem 105 is transmitted through the TIR prism pair and then interacts with the mirrors 110M. After having interacted with the mirrors 110M, light portions from mirrors in the first orientation state are reflected by a second prism of the pair onto the sensing path 115. Light portions from mirrors in the second orientation state may be reflected away from the sensing path.

### Adaptive Sensing of a Programmable Spatial Light Modulator System

In one set of embodiments, a method is proposed for adaptively sensing relevant and salient features in a signal or scene of interest, thereby enabling smarter and more efficient sampling.

In some embodiments, the proposed method may be summarized by the following steps:

(1) Design a sensing matrix whose rows are partitioned into discrete blocks, each of which contains some salient feature/aspect of the desired signal/image. The sensing matrix may be stored in the memory of a sensing device or imaging device, e.g., a device as variously described above.

(2) For each of the partitioned blocks, measure a statistic of the signal/scene that corresponds to the feature unique to that respective block.

(3) Use the collected statistics to determine a sensing schedule based on the salient characteristics of the observed scene.

### Partition the Sensing Patterns

The Partial-Complete Hadamard patterns outlined in U.S. patent application Ser. No. 14/154,817 are a good example of a matrix that has been designed to have blocks that contain distinct features, i.e., each block corresponds to a respective one of the distinct features. The partial-complete strategy partitions the sensing matrix into blocks that have distinct spatial frequencies and orientations.

### Measure Statistics

A relatively small number of sensing patterns from a block may be used to observe the signal/image in order to generate a statistic about correlation of a particular feature (e.g., spatial frequency) and the scene. For example, the measured variance or standard deviation of the measurements (obtained by applying the small number of sensing patterns) may be generated, and subsequently used to determine a robust sensing schedule, to be discussed in the next section. Each of the measurements may be obtained by applying a respective one of the small number of sensing patterns to the modulator (e.g., light modulation unit 110), and capturing the output of a sensing device (e.g., light sensing device 130).

Another approach is to obtain the statistics from measurements corresponding to a previously observed image if the scene is not changing or is slowly changing between images. (The set of measurements representing each image may be stored in memory. Thus, it is not necessary to operate on the measurements of the presently captured image.) This embodiment is analogous to a video camera, where the frame rate is high relative to motion in the scene. In this case, statistics about each of the blocks of patterns may be derived from the sensing achieved from the previous image.

A complementary strategy, once a subset of blocks and an appropriate sensing schedule has been determined (as described in the next section), is to continuously obtain statistics from subset of blocks that are not in the present sensing schedule. That is, a small number of rows from these complementary blocks can be used to sense the scene, and as described above, a sufficient statistic can be generated to detect energy of interest.

The per-block statistics may be updated on a per image basis or may include a filtered version of past statistics such as a weighted average.

An important feature of the partial-complete partitioning strategy is the use coarse random diagonal. Although not absolutely crucial in theory, it serves to spread out the information within each block, thereby reducing the dynamic range of the measurements. This spreading of information can help guarantee a robust statistic even when only a very small number of samples are taken per block.

Modify Sensing Strategy based on Statistics

In some embodiments, the following method may be used to modify a sensing strategy based on statistics:

(1) Initial sampling: Sample the signal/scene of interest using a relatively small number of patterns from each block (i.e., relatively small compared to the complete number of patterns in the block). In some embodiments, sampling less than one percent of each block can yield robust statistics. However, a wide variety of sampling percentages are possible, e.g., depending on the application context.

(2) Generate statistics: Using the samples (also known as measurements) collected in the previous step, generate one or more statistics for each block. For example, variance and standard deviation are well known statistics.

(3) Sort the block statistics in descending order. This sorting orders the features (i.e., the features represented by the respective blocks) based on the extent to which those features are present in the signal/scene under analysis.

(4) Determine the number of blocks, nB, and the number of patterns captured per image, M, to be used for sampling subsequent images of the scene (or subsequent portions of the signal).

(a) In some embodiments, M will be fixed, and the block statistics will determine nB. For example, a threshold may be applied to the sorted list of statistics. The blocks whose statistics exceed the threshold may be selected for use in subsequent sampling, and nB is defined as the number of those threshold-exceeding blocks.

(b) In some embodiments, nB will be fixed and the block statistics will determine M. For example, M can be determined such that in the block with the smallest statistic (i.e., the nB'th block), the number of samples in this block still has a minimum density, e.g., 10% of B, where B is the number of rows in that block. If this lowest density is previously set, then M can be determined from the relative densities of all of the other block statistics.

(c) In some embodiments, the block statistics will be used to determine both M and nB.

(5) Select the first nB blocks according to the sorted descending order.

(6) For the selected blocks, determine a density (i.e., number of patterns) per block, based on the relative statistics per block, such that the total number of patterns used is equal to M. For example, the relative magnitudes of the variances of the selected blocks can be used to specifically determine the sampling density within the selected blocks.

(a) In some embodiments, the partial sampling of one or more of the selected blocks may be done in a random manner (e.g., uniform random sampling within a given block). Partial sampling refers to the action of using some but not all of the patterns (i.e., rows) within each of the selected blocks.

(a) In some embodiments, the partial sampling of one or more of the selected blocks may be done in a deterministic manner.

In some embodiments, one or more blocks may be completely sampled. Complete sampling of a given block refers to the action of using all of the patterns (i.e., rows) within the given block.

(7) Acquire additional measurements for each of one or more additional images (or signal portions) based on rows drawn from the selected blocks, e.g., using any combination of the partial sampling and/or complete sampling technicques described above.

### Process the Data

Use the acquired data to process the scene of interest. In some embodiments, this will require the use of a reconstruction algorithm.

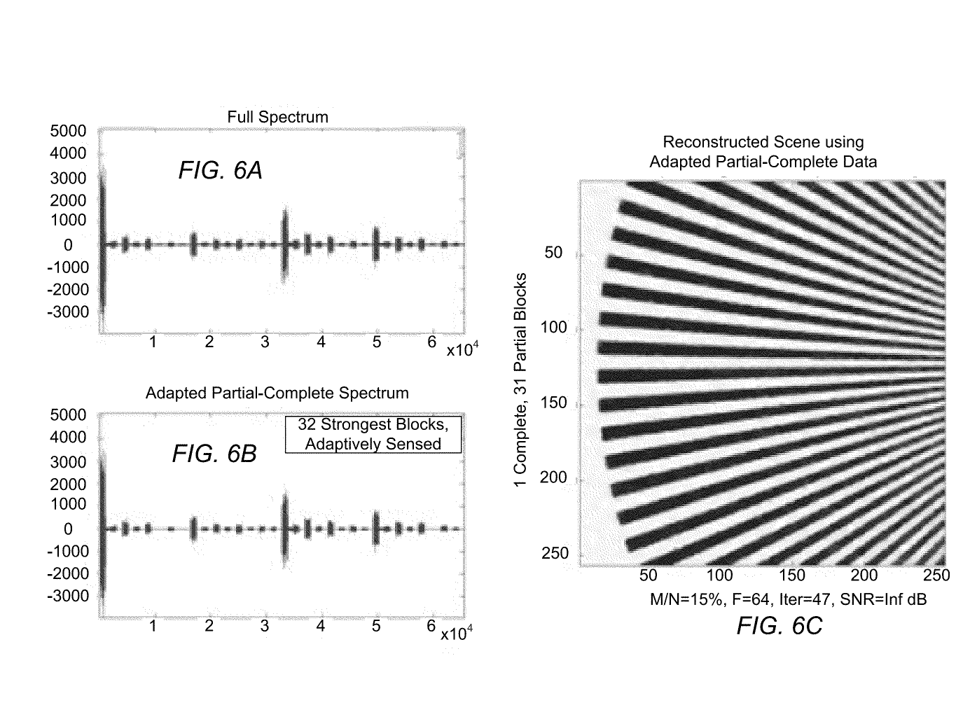

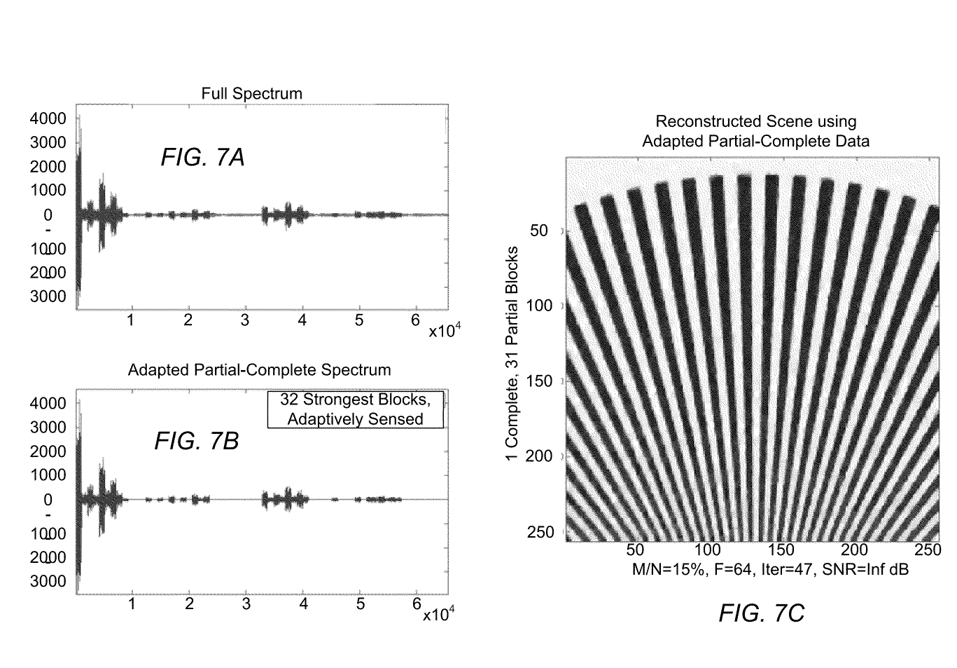

FIGS. 6A-6C illustrate a close-up of horizontal spokes in a star-sector target. FIG. 6A shows the full spectrum of a Hadamard domain, partitioned into F=64 signature blocks. (Compare which blocks have significant energy here as compared to FIG. 7A.) FIG. 6B shows the “Partial-Complete” measurements that were selected from strongest thirty-two (32) blocks. FIG. 6C shows the reconstructed image resulting from the “Partial-Complete” measurements.

FIGS. 7A-7C illustrate a close-up of vertical spokes in a star-sector target. FIG. 7A shows the full spectrum of a Hadamard domain, partitioned into F=64 signature blocks. (Compare which blocks have significant energy here as compared to FIG. 6A.) FIG. 7B shows the “Partial-Complete” measurements that were selected from strongest thirty-two (32) blocks. FIG. 7C shows the reconstructed image resulting from the “Partial-Complete” measurements.

Any of the various embodiments described herein may be realized in any of various forms, e.g., as a computer-implemented method, as a computer-readable memory medium, as a computer system. A system may be realized by one or more custom-designed hardware devices such as ASICs, by one or more programmable hardware elements such as FPGAs, by one or more processors executing stored program instructions, or by any combination of the foregoing.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a computer system may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The computer system may be realized in any of various forms. For example, the computer system may be a personal computer (in any of its various realizations), a workstation, a computer on a card, an application-specific computer in a box, a server computer, a client computer, a hand-held device, a mobile device, a wearable computer, a sensing device, an image acquisition device, a video acquisition device, a computer embedded in a living organism, etc.

Any of the various embodiments described herein may be combined to form composite embodiments. Furthermore, any of the various features, embodiments and elements described in U.S. Provisional Application No. 61/753,359 may be combined with any of the various embodiments described herein.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method for sensing signals and/or images, the method comprising:
(a) acquiring a set of measurements corresponding to a signal or image from a signal sensing system using a sensing matrix whose rows are partitioned into discrete blocks, wherein each of the measurements corresponds to a respective one of the rows of the sensing matrix, wherein for each of the blocks, the set of measurements includes a corresponding subset of measurements acquired using selected rows from the block, wherein each of the blocks corresponds to a respective signature unit cell from a set of signature unit cells, wherein each of the signature unit cells corresponds to a respective feature from a set of features, wherein each block is a set of patterns formed from distinct arrangements of the corresponding signature unit cell;
(b) for each of the blocks, computing a corresponding statistic based on a corresponding subset of the measurements; and
(c) determining a sensing schedule using the computed statistics.

2. The method of claim 1, further comprising:
acquiring additional measurements from signal sensing system using the sensing schedule; and
reconstructing a new image based on the additional measurements.

3. The method of claim 1, further comprising:
acquiring additional measurements from the signal sensing system using the sensing schedule;
detecting a feature, event or other information present in an external environment based on the additional measurements.

4. The method of claim 1, further comprising:
acquiring additional measurements from the signal sensing system using the sensing schedule for imaging and non-imaging purposes that are: efficient in the number of required measurements, efficient in acquisition time, efficient in reconstruction time, or lead to other enhanced characteristics in the resulting data.
